(19) United States
(12) Patent Application Publication
(10) Pub. No.: US 2006/0278803 A1
(43) Pub. Date: Dec. 14, 2006

(54) Method for manufacturing a vehicular lamp and a vehicular lamp

(75) Inventor: Mitsuyuki Mochizuki, Shizuoka-shi (JP)

Correspondence Address: KODA & ANDROLIA, 2029 CENTURY PARK EAST, SUITE 1140, LOS ANGELES, CA, 90067, US

(73) Assignee: Koito Manufacturing Co., Ltd.

(21) Appl. No.: 11/405,987

(22) Filed: Apr. 18, 2006

(30) Foreign Application Priority Data
Apr. 19, 2005 (JP) 2005-121172

(51) Int. Cl. A01K 97/10; A45B 25/28; A47G 25/12; A47G 33/12; H01Q 1/12

(52) U.S. Cl. 248/538

(57) ABSTRACT

A vehicular lamp 1 hving a front lens 3 provided with a wire 6 for heating the front lens being manufactured by a shape-forming step in which a resin plate 7 is formed into a predetermined shape so that at least a part of the resin plate acts as at least a part of a light emission surface portion 3a of the front lens, an insertion step in which the resin plate thermally installed with a wire 6 is set at a position in a molding die 200 where the light emission surface portion of the front lens is to be formed, and a formation step in which a melted resin is injected into a molding die to form by injection molding the front lens. The vehicular lamp thus manufactured is provided with a front lens that has a wire-installed resin plate therein as the light emission surface portion.

### BACKGROUND OF THE INVENTION

1. Field of the Invention

The present invention relates to a vehicular lamp manufacturing method and to a vehicular lamp and more particularly to a method for manufacturing a vehicular lamp that has a heating wire therein and to such a vehicular lamp.

2. Description of the Related Art

In some vehicular lamps, a wire is installed in the front lens so that the wire is electrically heated for the purpose of defrosting the front lens and melting snow on the front lens.

As shown in FIG. 11, in such vehicular lamps, the front lens a generally includes a light emission surface portion b that emits light from the light source of the lamp and a flange portion c that is provided along the perimeter of the light emission surface portion b and is attached to the lamp body.

In the above structure, since the flange portion c is provided along the perimeter of the outer peripheral portion of the light emission surface portion a, the flange portion c would interfere with an installation of the heating wire. In other words, during the wire installation operation using a wire installation head d that installs a wire (heating wire) e in the light emission surface portion a, the flange portion c of the front lens a would obstruct the movement of the wire installation head d.

### BRIEF SUMMARY OF THE INVENTION

Accordingly, it is an object of the present invention to provide a method for manufacturing a vehicular lamp and a vehicular lamp manufactured thereby in which a vehicular lamp provided with a heater (or heating wire) is manufactured easily.

The above object is accomplished by unique steps of the present invention for a method of manufacturing a vehicular lamp, and in the present invention, the method comprises a shape-forming step in which a resin plate is formed into a predetermined shape so that at least a part of the resin plate acts as at least a part of the light emission surface portion; an insertion step in which the resin plate in which a wire (heating wire) is installed by heat is set at a position in a molding die where at least the light emission surface portion of the front lens is to be formed; and a formation step in which a melted resin is injected in the molding die to form the front lens that has the resin plate fixed thereto by injection molding.

The above object is further accomplished by a unique structure of the present invention for a vehicular lamp that includes a front lens which is formed by insert molding and is provided with a resin plate so that at least a part of the resin plate, which is installed with a wire (heating wire) by heat, forms at least a part of the light emission surface portion of the front lens.

As seen from the above, according to the present invention, the front lens is provided with a resin plate which is installed in advance with the wire (heating wire), and such front lens is obtained by injection molding with the resin plate set in the molding die.

More specifically, the vehicular lamp manufacturing method of the present invention is a method for manufacturing a vehicular lamp in which the front lens is provided with a wire for heating the front lens, and the front lens includes a light emission surface portion that emits light from the light source and a flange portion that projects from the outer peripheral edge of the light emission surface portion and is attached to the lamp body; and in the present invention, the method includes a shape-forming step in which a resin plate is formed into a predetermined shape so that at least a part of the resin plate acts as at least a part of the light emission surface portion, an insertion step in which the resin plate installed with a wire by heat is inserted and set at a position in a molding die where at least the light emission surface portion of the front lens is to be formed; and a formation step in which a melted resin is injected in the molding die to form the front lens by injection molding.

Accordingly, in the present invention, during the wire installation operation, the flange portion of the front lens does not obstruct the movement of a wire installation head that performs the wire installation operation; and it is, therefore, possible to easily manufacture the vehicular lamp.

In the present invention, ultrasonic wire installation can be employed for installing the heating wire in the resin plate. More specifically, in the present invention, a resin plate is subjected to ultrasonic vibration so as to be heated and melted, thus allowing at least a portion of the heating wire to be embedded in the resin plate. With the use of ultrasonic wire installation, the apparatus for thermally installing the heating wire in the resin plate can be simple in structure and the operation time of such apparatus can be shortened.

Furthermore, in the present invention, the heating wire is installed so that it comprises a plurality of vertical wire portions that extend in the vertical direction of the resin plate and a plurality of connecting portions that connect respective ends of adjacent vertical wire portions, and the length of (each one of) the vertical wire portions is set to be longer than the length of (each one of) the connecting portions. With this arrangement, light of the lamp is much less apt to diffuse vertically, and it is thus possibled to reduce the generation of glare light.

In addition, in the present invention, the resin plate is preferably 2 mm to 4 mm in thickness. Accordingly, no deformation occurs in the resin plate due to the pressure from the wire installation head during the wire installation operation; and thus, the wire installation operation is achieved appropriately with ease.

Furthermore, the vehicular lamp of the present invention is a vehicular lamp in which the front lens is provided with a wire for heating the front lens, and the front lens includes a light emission surface portion that emits light from the light source and a flange portion that is on the outer peripheral edge of the light emission surface portion and is attached to a lamp body; and in this structure, the front lens is formed by insert molding such that at least a part of a resin plate which is thermally installed with a wire (heating wire) comprises at least a part of the light emission surface portion.

Accordingly, in the vehicular lamp of the present invention, the lamp is obtained such that during the wire installation operation, the flange portion of the front lens does not obstruct the movement of the wire installation head that performs the wire installation, and thus the lamp is manufactured easily.

### BRIEF DESCRIPTION OF THE SEVERAL VIEWS OF THE DRAWINGS

FIG. 1 is a cross-sectional view of the vehicular lamp according to the present invention;

FIG. 2 is a front elevational view thereof; 5 FIG. 3 is a conceptual diagram of a molded resin plate which is used in the present invention;

FIG. 4 is a front elevational view of the resin plate with trimming performed;

FIGS. 5A through 5C show the procedure of installing the wire (heating wire) in the resin plate by heat, wherein FIG. 5A shows a standby state prior to the installation of the wire, FIG. 5B shows the wire installation state, and FIG. 5C shows the state that the wire installation is completed;

FIG. 6 is an enlarged cross-sectional view of the wire partially embedded in the resin plate by heat;

FIG. 7 is a cross-sectional view of the molding die with the resin plate set inside; and FIG. 8 is an enlarged cross-sectional view of the state in which a coating layer is formed on the front lens;

FIG. 9A shows light distribution characteristics of the light emitted from a light source of the vehicular lamp of the present invention in which the wire is vertically arranged, and FIG. 9B shows light distribution characteristics of the light emitted from a light source of a vehicular lamp in which the wire is horizontally arranged;

FIG. 10 is a perspective view of another shape of the resin plate with a wire installation head shown additionally; and

FIG. 11 is a conceptual diagram showing the conventional wire installation operation.

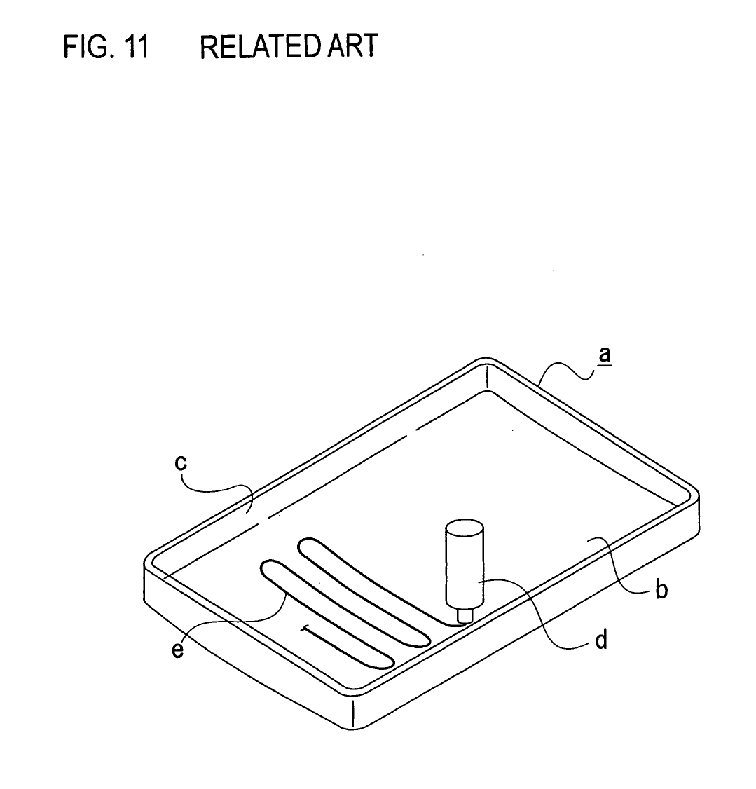

### DETAILED DESCRIPTION OF THE INVENTION

The preferred embodiments of the vehicular lamp manufacturing method and of the vehicular lamp according to the present invention will be described below with reference to the accompanying drawings.

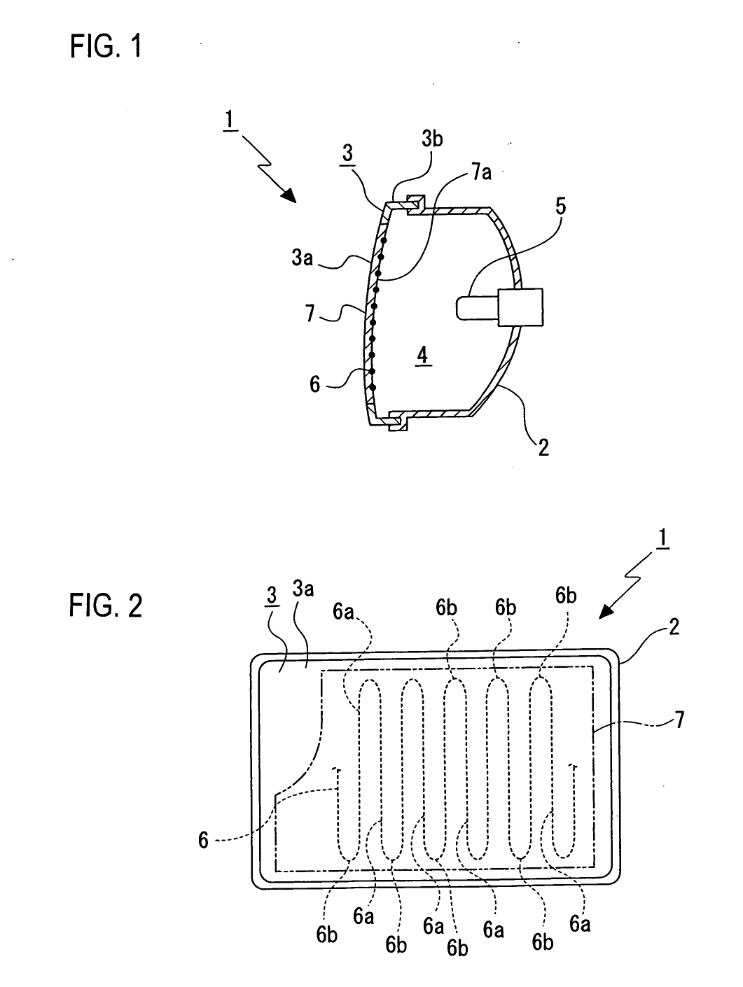

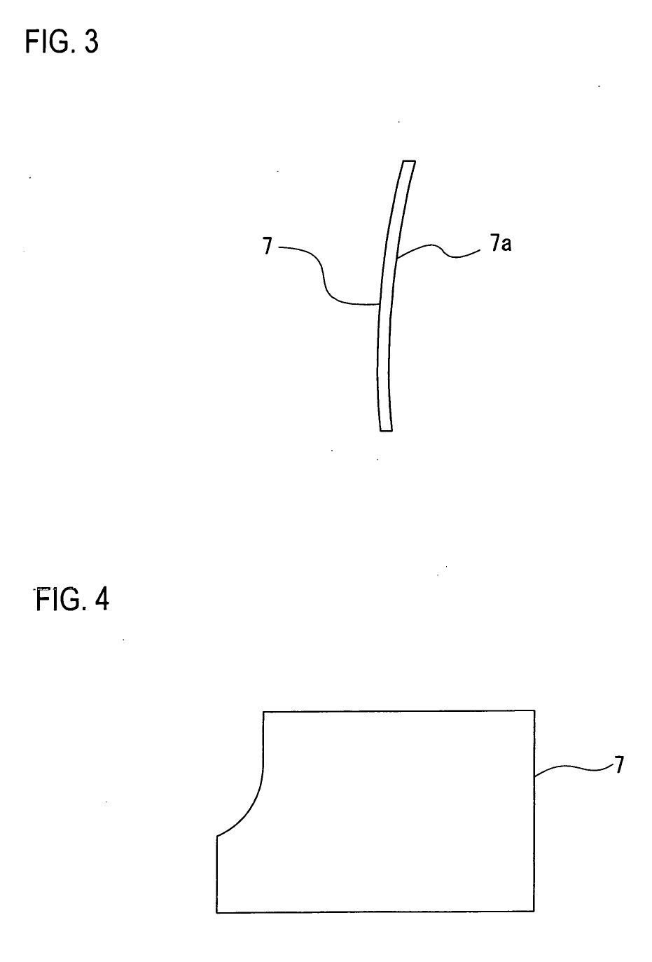

FIGS. 1 and 2 schematically show an example of the vehicular lamp manufactured according to the vehicular lamp manufacturing method of the present invention.

The vehicular lamp 1 is, for example, a front lamp for an automobile, and it includes a lamp body 2 with its concave portion open in the front, and a front lens 3 that closes the front opening of the lamp body 2. The internal space defined by the lamp body 2 and the front lens 3 makes a lamp chamber 4. Attached to the lamp body 2 is a light source bulb 5 that is disposed inside the lamp chamber 4. The light source bulb 5 is, for example, a discharge bulb, but a light source other than the discharge bulb including an incandescent bulb such as a halogen bulb, or a light-emitting diode and the like can be used.

The front lens 3 is comprised of a light emission surface portion 3a that emits light from the light source bulb 5 substantially forward and a flange portion 3b that projects substantially rearward from the outer peripheral portion (or the outer peripheral edge) of the light emission surface portion 3a. The end portion of the flange portion 3b is attached to the front end portion of the lamp body 2.

A wire (heating wire) 6 such as copper wire that can be electrically heated is embedded in and fixed to the inner surface side of the light emission surface portion 3a of the front lens 3. As shown in FIG. 2, the wire 6 comprises a plurality of vertical wire portions 6a that extend in the vertical direction (an up-down direction) of the front lens 3 and a plurality of connecting portions 6b that connect the respective ends of adjacent vertical wire portions 6a. The length of (each one of) the vertical wire portions 6a is set to be longer than the length of (each one of) the connecting portions 6b.

The diameter of the wire 6 is preferably 0.05 mm to 0.2 mm. If the wire diameter is too small (or smaller than 0.05 mm), the risk of short-circuiting increases. If the wire diameter is too large (or larger than 0.2 mm), then light rays passing through the front lens 3 may be blocked, adversely affecting the light distribution of the lamp 1 and making the wire 6 conspicuous, worsening the appearance of the front lens 3.

The space between adjacent vertical wire portions 6a of the wire 6 may be in the range from 5 mm to 25 mm. If the space between the vertical wire portions 6a is too small, light distribution is greatly affected; and if the wire space is too large, then a desired heat amount is not obtainable.

In the vehicular lamp 1 as described above, when the electric current flows in the wire 6 installed in the front lens 3, the wire 6 is heated, increasing the temperature for the portion of the front lens 3 where the wire 6 is provided. As a result, the generated heat melts snow on the surface of the front lens 3 and defrosts the inside and outside of the front lens 3.

Next, the manufacturing method of the front lens 3 will be described (see FIGS. 3 to 8).

First, a resin plate 7 is pre-formed so as to have a shape that forms at least a part of the light emission surface portion 3a of the front lens 3 (a shape-forming step). Material similar to a melted resin, which is injected into a cavity of the molding die during injection molding described later, may be used for the resin plate 7, such as polycarbonate or acrylic resin, for example. The thickness of the resin plate 7 is preferably 2 mm to 4 mm.

The pre-forming of the resin plate 7 is performed by a so-called thermoforming, which involves heating and softening of a resin plate 7, and subsequently pressing the resin plate 7 against a die by vacuum suction or pneumatic pressure or compressing the resin plate 7 between two dies. The flat resin plate 7 can thus be formed into a curved shape, for example, by thermoforming (see FIG. 3).

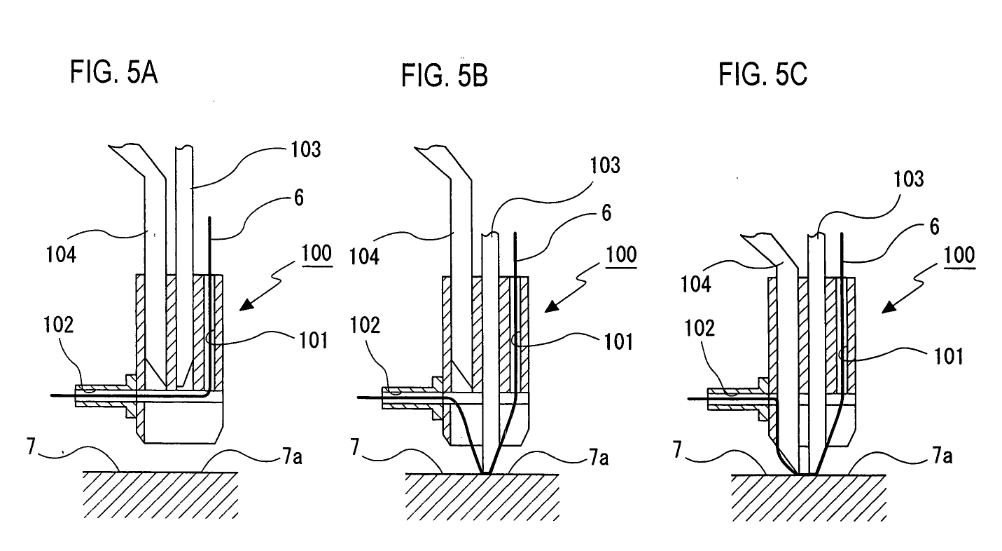

Trimming is next performed on the resin plate 7. More specifically, the resin plate 7 molded into a curved surface shape by thermoforming as described above is cut so that the resin plate 7 has a desired exterior contour (see FIG. 4). A cutting tool such as a cutter is used to perform the trimming.

Next, the wire 6 is installed by heat or thermally installed in the resin plate 7 which is trimmed into a desired exterior contour (a wire-installation step). The thermal installation is an operation where heat is applied to a substrate (the resin plate 7 in the present invention), on which the wire 6 is installed, so as to heat and soften the substrate (the resin plate 7), after which the wire 6 is pressed into heated and softened locations of the substrate such that the wire 6 is as least partially embedded in the substrate (the resin plate 7). Means for heating the substrate include, for example, applying the ultrasonic vibration to the substrate or pressing a heated pressing member against the substrate.

Wire installation by heat or thermal wire installation is performed using, for example, a wire installation head as described in Japanese Patent No. 3190345.

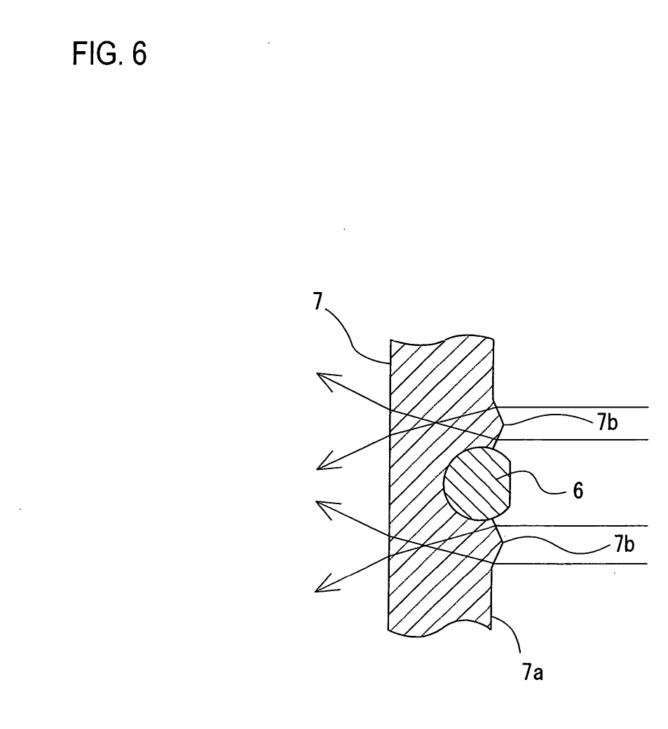

In the standby state as shown in FIG. 5A, the wire 6 is first inserted into the guide portions 101 and 102 of a wire installation head 100 so that the wire 6 is inside a generally L-shaped route.

In the next step, as shown in FIG. 5B, a pressing arm 103 is projected out. Upon projection of the pressing arm 103, the wire 6 is pushed by the tip end of the pressing arm 103 and pushed out of the guide portion 102, and the wire 6 is pressed onto the wire-installation surface 7a of the resin plate 7 by the tip end of the pressing arm 103.

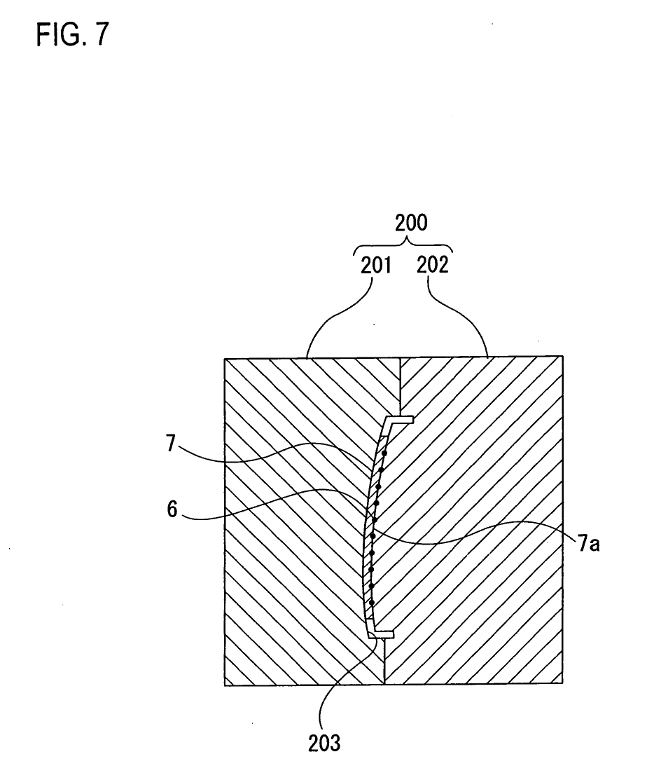

Next, the tip portion of the pressing arm 103 is heated, or an ultrasonic vibration is applied to the pressing arm 103. Once the tip portion of the pressing arm 103 is heated, or ultrasonic vibration is applied to the pressing arm 103, the portion of the resin plate 7 with the wire 6 being pressed thereon is heated and softened. As a result, with a predetermined pressure applied to the pressing arm 103 toward the resin plate 7, the wire 6 is pressed by the pressing arm 103 and is subsequently softened by the heating and pushed into the resin plate 7 (see FIG. 6).

As seen from the above, the pressing arm 103 is heated or subjected to ultrasonic vibration; and in this state, the predetermined pressure is applied toward the resin plate 7, and the wire installation head 100 is moved along a predetermined route. As a result, the wire 6 is embedded in the resin plate 7 at a predetermined position and in a predetermined pattern.

When the wire installation head 100 is moved to a wire installation termination position, the tip end of the cutter 104 projects out as shown in FIG. 5C and cuts the wire 6.

In the above-described wire installation, the wire 6 is embedded in the resin plate 7 except its two end portions, and the two end portions of the wire 6 not embedded are raised from the resin plate 7 and, as described below, are connected to terminals (not shown).

Following the completion of the installation of the wire 6 by heat in the resin plate 7, the two end portions of the wire 6 are respectively connected to the terminals that have been fixed in advance to the resin plate 7. Connection of the end portions of the wire 6 to the terminals is achieved by winding the two end portions of the wire 6 around the respective terminals and fixing them by welding.

As seen from the above, the wire 6 is installed in any desired pattern by way of moving the wire installation head 100 in a predetermined desired path, and the connection of the two end portions of the wire 6 to the respective terminals are made, thus completing the wire installation.

As seen from the above, in the present invention, trimming is first performed to form the resin plate 7 into a desired shape, and then the wire 6 is thermally installed in the resin plate 7. These steps make separation of the wire 6 from the resin plate 7 and short-circuiting of the wire 6 less likely to occur than in the case of installing the wire first and then performing the trimming for the wire-installed resin plate.

Also, since in the present invention the resin plate 7 has the thickness of 2 mm to 4 mm, the resin plate 7 does not deform by the pressure of the wire installation head 100 during the wire installation operation, and thus the wire installation operation is achieved with ease.

Furthermore, since the resin plate 7 has the thickness of 2 mm to 4 mm, it can be ensured that the front lens 3 has a predetermined strength needed for functioning as the front lens 3; and since the thickness is not excessive, excellent thermal conductivity is secured for the front lens when the wire 6 generates the heat.

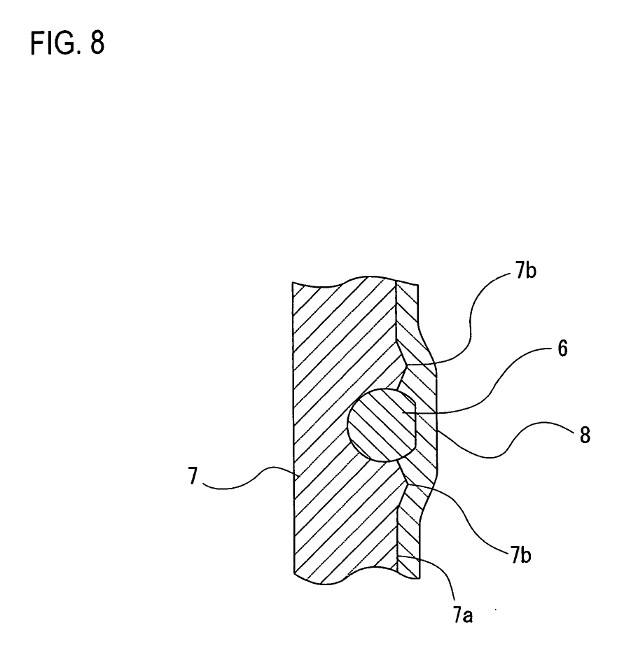

The resin plate 7 formed as described above is next inserted into and set in a molding die 200 (an insertion step). As shown in FIG. 7, the molding die 200 is comprised of a fixed die 201 and a movable die 202; and it has a cavity 203 formed by and between the fixed die 201 and the movable die 202. The cavity 203 has the size of the front lens 3.

The resin plate 7 is set in the cavity 203 such that the wire 6 faces the inner surface side of the front lens 3 to be molded.

Following the insertion or setting of the resin plate 7.inside the molding die 200, a melted resin that will serve as material for the front lens 3 is injected into the cavity 203 to form the front lens 3 (a formation step). The heat of the injected melted resin softens the outer peripheral surface of the resin plate 7 that is in contact with the melted resin. Consequently, the outer peripheral surface of the resin plate 7 and the portion of the melted resin in contact with the resin plate 7 attain a mutually melted state, and cooling and hardening of the melted resin bring the formation of the front lens 3 with the resin plate 7 making a part of the light emission surface portion 3a of the front lens 3.

The front lens 3 is then extracted from the cavity 203 by separating the movable die 202 from the fixed die 201.

Meanwhile, in the state that the wire 6 is embedded in the resin plate 7 (or in the wire-installation surface 7a) by heat, the wire 6 is, as seen from FIG. 6, only partially embedded in the resin plate 7. Moreover, the material for the resin plate 7, which was pressed during the installation or embedding process of the wire 6, protrudes out in a bank formation along the wire 6, forming bulged bank portions 7b. The distance between the bulged bank portions 7b on both sides of the wire 6 is greater than the diameter of the wire 6; and therefore, the appearance of the resin plate 7 deteriorates. Furthermore, the bulged bank portions 7b would act as prisms for light rays, causing the light distribution to be disrupted due to diffuse reflection or diffuse refraction occurring at the bulged bank portions 7b and the like (arrows in FIG. 6 represent paths of the light rays incident to the bulged bank portions 7b.) Accordingly, in the state that the wire 6 is embedded in the resin plate 7, the bulged bank portions 7b become conspicuous, worsening the appearance of the vehicular lamp 1.

In view of the above, in the vehicular lamp 1 of the present invention, after installing the wire by the wire installation head 100, the wire-installation surface 7a of the resin plate 7 is coated with a coating layer 8 which is made of transparent resin (see FIG. 8). With the formed coating layer 8, the wire 6 is covered by the coating layer 8 and the surface in which the wire 6 is embedded becomes smoother. Accordingly, the portions other than the wire 6, for example, the swelled bank portions 7b, do not stand out and the appearance of the vehicular lamp 1 is improved.

The coating layer 8 is preferably formed by a resin that has a refractive index similar to the material for the front lens 3. As a result, the swelled bank portions 7b lessen the light refraction and provide less adverse effects to the light distribution of the lamp 1.

With the coating layer 8 covering the wire 6, separation of the wire 6 from the front lens 3 is prevented. Furthermore, since the wire 6 is not exposed to air, it is possible to prevent changes in its resistance value, discoloration, and deterioration due to the oxidation, etc. of the wire 6.

Lastly, the front lens 3 manufactured as described above is mounted in the lamp body 2, and the terminals connected to the wire 6 are connected to a power source via connectors (not shown) so that the wire 6 is brought into a state capable of being supplied with electricity.

As seen from the above, in the vehicular lamp 1 of the present invention, the wire 6 is installed in the resin plate 7 that is acting as a light emission surface portion of the front lens 3; and during the wire installation operation of the wire 6 by the wire installation head 100, the flange portion 3b of the front lens 3 does not obstruct the movement of the wire installation head 100 that performs the wire installation operation. It is thus possible to easily manufacture the vehicular lamp 1.

Furthermore, in the present invention, ultrasonic wire installation is employed for installing the wire 6 by heat, wherein the resin plate 7 is subjected to ultrasonic vibration, and thus heated and melted, so that at least a portion of the wire 6 is embedded in the resin plate 7. This makes the apparatus for thermally installing the wire simpler in structure and the operation time of such apparatus shorter.

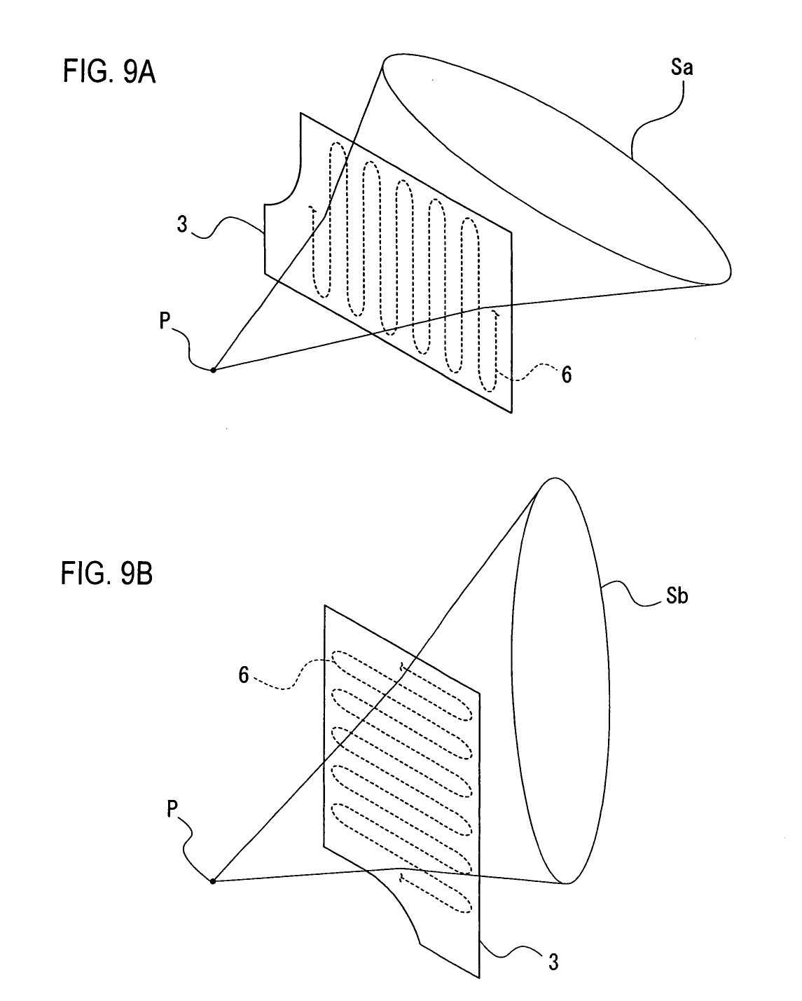

In the vehicular lamp 1 of the present invention, the length of (each one of) the vertical wire portions 6a of the wire 6 is set longer than the length of (each one of) the connecting portions 6b as described above. Accordingly, as seen from FIG. 9A, diffuse refracted light, which is generated by the bulged bank portions 7b around the wire 6 and is among the light emitted from the light source P and passes through the front lens 3, is diffused horizontally to generate a horizontally oblong-shaped diffuse refracted light distribution Sa.

On the other hand, if the wire 6 is provided so that it comprises mainly portions that extend in the horizontal direction as shown in FIG. 8B, then diffuse refracted light, which is generated by the bulged bank portions 7b around the wire 6 and is among the light emitted from the light source P and passes through the front lens 3, is diffused vertically, generating a vertically oblong-shaped diffuse refracted light distribution Sb. When such a vertically oblong-shaped diffuse refracted light distribution Sb is generated, glare light is more likely to occur to the oncoming vehicles.

As seen from the above, with the setting of the length of the vertical wire portions 6a of the wire 6 longer than the length of the connecting portions 6b, light is much less apt to diffuse vertically, thus reducing the generation of glare light.

In the above description, the wire 6 is installed after the formation of the resin plate 7 in a predetermined shape. Alternatively, the resin plate 7 can be formed into a predetermined shape after installing the wire 6 in a flat resin plate. By first installing the wire 6 in a flat resin plate, the wire installation operation is further simplified.

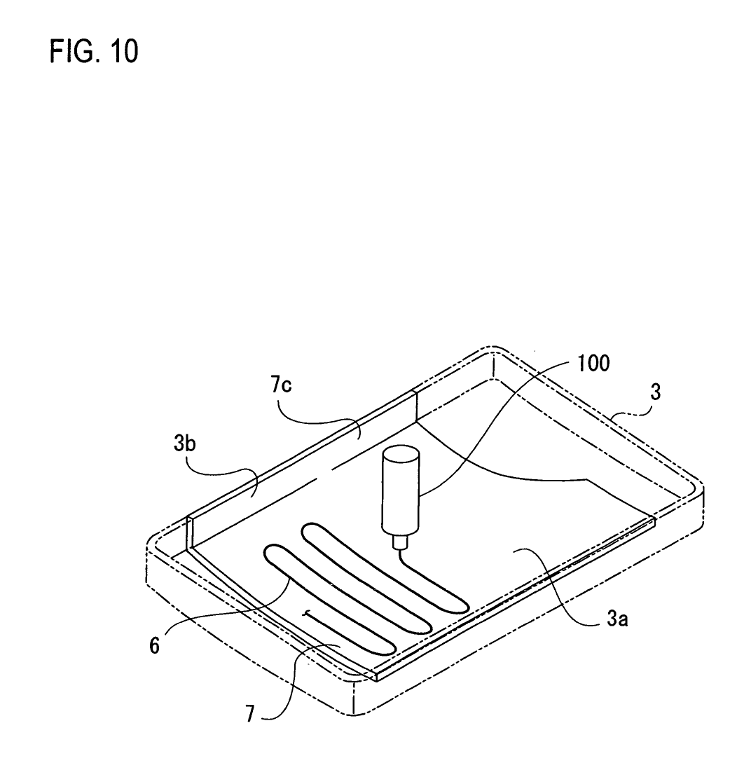

In addition, in the above description, the resin plate 7 serves as a part of the light emission surface portion 3a of the front lens 3. However, the resin plate 7 can be designed so that it serves as both the light emission surface portion 3a and the flange portion 3b of the front lens 3. For example, as shown in FIG. 10, one side edge portion 7c of the resin plate 7 can be formed so as to be the flange portion 3b; and with this structure, during the wire installation operation of the wire 6 by the wire installation head 100, the flange portion 3b is much less likely to obstruct the movement of the wire installation head 100, and manufacturing of the vehicular lamp 1 can be thus simplified.

The shapes and configurations of the respective portions described and shown in the above embodiments are all merely one specific example for carrying out the present invention, and they must not be interpreted to limit the technical scope of the present invention in any manner.

1. A method for manufacturing a vehicular lamp in which a front lens thereof is provided with a wire for heating the front lens, and the front lens comprises a light emission surface portion that emits light from a light source of the lamp and a flange portion that projects from an outer peripheral edge of the light emission surface portion and is attached to a lamp body of the lamp, said method comprising the steps of:
forming a resin plate into a predetermined shape so that at least a part of the resin plate acts as at least a part of the light emission surface portion;
setting the resin plate installed with the wire at a position in a molding die where at least the light emission surface portion of a front lens is to be formed; and
executing an injection molding for molding the front lens, which has therein the resin plate, by way of injecting a melted resin into the molding die.

2. The method for manufacturing a vehicular lamp according to claim 1, said method further comprising, before said step of forming a resin plate into a predetermined shape, the step of installing a wire in the resin plate by heat.

3. The method for manufacturing a vehicular lamp according to claim 1, said method further comprising, after said step of forming a resin plate into a predetermined shape, the step of installing a wire in the resin plate by heat.

4. The method for manufacturing a vehicular lamp according to claim 1, wherein
the resin plate is subjected to ultrasonic vibration so as to be heated and melted, thus allowing at least a portion of the wire is embedded in the resin plate.

5. The method for manufacturing a vehicular lamp according to claim 1, wherein
the wire installed comprises a plurality of vertical wire portions that extend in a vertical direction of the resin plate and a plurality of connecting portions that connect respective ends of adjacent vertical wire portions, and
a length of the vertical wire portions is set to be longer than a length of the connecting portions.

6. The method for manufacturing a vehicular lamp according to claim 1, wherein
the resin plate has a thickness of 2 mm to 4 mm.

7. The method for manufacturing a vehicular lamp according to claim 1, further comprising the step of forming a coating layer that covers the wire installed in the resin plate.

8. A vehicular lamp in which a front lens thereof is provided with a wire for heating the front lens, and the front lens comprises a light emission surface portion that emits light from a light source of the lamp and a flange portion that is provided on an outer peripheral edge of the light emission surface portion and is attached to a lamp body of the lamp, wherein
the front lens is formed by insert molding, and
at least a part of the light emission surface portion is comprised of at least a part of a resin plate that is installed with the wire by heat.

9. The vehicular lamp according to claim 8, further comprising a coating layer provided on said resin plate so as to cover said wire installed in said rein plate.
